(19) United States
(12) Patent Application Publication
(10) Pub. No.: US 2017/0198576 A1
(43) Pub. Date: Jul. 13, 2017

(54) HOLDER FOR CUTTING TOOL

(71) Applicant: Caterpillar Inc., Peoria, IL (US)

(72) Inventors: Andrew D. Steinmetz, Peoria, IL (US); Timothy A. Thorson, Morton, IL (US); Thierry Marchione, Heber City, UT (US)

(73) Assignee: Caterpillar Inc., Peoria, IL (US)

(21) Appl. No.: 14/994,391

(22) Filed: Jan. 13, 2016

(51) Int. Cl. E21C 35/183; C23C 30/00; B23B 27/00

(52) U.S. Cl. CPC E21C 35/183; B23B 27/00; C23C 30/005; B23B 2228/10; B23B 2222/16; E21C 2035/1803

(57) ABSTRACT

A method of selectively hardfacing a holder of a cutting tool is provided. The method includes creating a groove on an outer surface of the holder. The method also includes applying a wear resistant material within the groove of the holder to form a wear resistant layer. The method includes heat treating the holder having the wear resistant layer.

### TECHNICAL FIELD

The present disclosure relates to cutting tools; and more particularly to a cutting tool and a method of selectively hardfacing a holder of a cutting tool.

### BACKGROUND

A cutting tool includes a holder and a cutting tip. The cutting tip is brazed to the holder. The cutting tip generally includes a carbide cutting tip. Current cutting tool designs lead to a failure of the holder before the cutting tip is completely worn out. This leads to wasted usable life of the cutting tip and extra owning and operating costs for customers. The failure of the holder before the cutting tip is completely worn out also reduces replacement interval time, which is not desirable.

U.S. Pat. No. 8,753,755 describes a body, such as a pick tool for cutting coal. The pick tool includes a steel substrate and a hard face structure fused to the steel substrate. The hard face structure includes at least 1 weight percent Si, at least 5 weight percent Cr and at least 40 weight percent W. Substantially the balance of the hard face structure includes carbon and an iron group metal M selected from Fe, Co, Ni and alloy combinations of these elements. The hard face structure includes a plurality of elongate or platelike micro-structures having a mean length of at least 1 micron, a plurality of nano-particles having a mean size of less than 200 nanometers, and a binder material.

### SUMMARY OF THE DISCLOSURE

In one aspect of the present disclosure, a method of selectively hardfacing a holder of a cutting tool is provided. The method includes creating a groove on an outer surface of the holder. The method also includes applying a wear resistant material within the groove of the holder to form a wear resistant layer. The method includes heat treating the holder having the wear resistant layer.

In another aspect of the present disclosure, a holder for a cutting tool is provided. The holder includes a shank portion. The holder also includes a head portion coupled to the shank portion. One end of the head portion comprises a cutting tool tip. The holder further includes a groove created in the head portion. A wear resistant layer is formed on the head portion by cladding a wear resistant material within the groove. Further, the holder is heat treated after forming the wear resistant layer.

In yet another aspect of the present disclosure, a cutting tool is provided. The cutting tool includes a holder. The holder includes a shank portion. The holder also includes a head portion coupled to the shank portion. The holder further includes a groove created in the head portion. A wear resistant layer is formed on the head portion by cladding a wear resistant material within the groove. Further, the holder is heat treated after forming the wear resistant layer. The cutting tool also includes a cutting tool tip coupled to one end of the head portion.

Other features and aspects of this disclosure will be apparent from the following description and the accompanying drawings.

### BRIEF DESCRIPTION OF THE DRAWINGS

FIG. 1 is a perspective view of an exemplary cutting tool having a holder, according to one embodiment of the present disclosure;

FIG. 2 is a cross-sectional view of the holder of the cutting tool, the holder having a groove;

FIG. 3 is a cross-sectional view of the holder having a wear resistant layer;

FIG. 4 is a perspective view of the holder having the wear resistant layer; and

FIG. 5 is a flowchart for a method of selectively hardfacing the holder of the cutting tool.

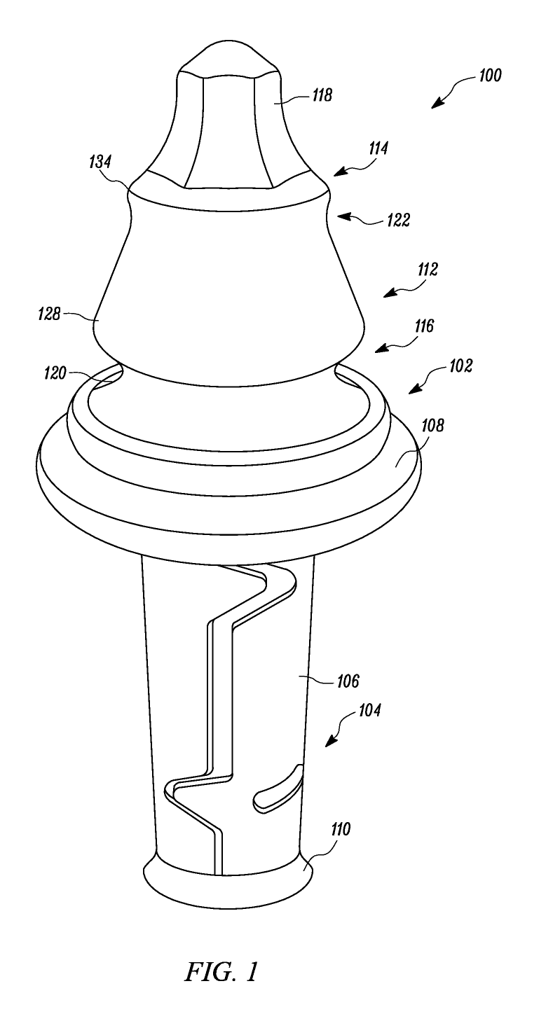

### DETAILED DESCRIPTION

Wherever possible, the same reference numbers will be used throughout the drawings to refer to the same or the like parts. FIG. 1 is a perspective view of a cutting tool 100, according to one embodiment of the present disclosure. The cutting tool 100 may be used for machining, breaking into, boring, or degrading structures, such as, rock, asphalt, coal, metals, or concrete. The cutting tool 100 may be used in applications including, but not limited to mining, construction, and road reconditioning. The cutting tool 100 may be selected from the group consisting of drill bits, asphalt picks, mining picks, hammers, indenters, shear cutters, indexable cutters, and combinations thereof, without any limitations.

In one example, the cutting tool 100 may be used in metal working applications, and can be mounted on a machine tool (not shown), such as a milling machine, lathe, and the like. In another example, a number of the cutting tools 100 may be mounted on a rotatable drum and operated to break up road asphalt, rock formations in coal mining, etc., based on a rotation of the drum.

The cutting tool 100 includes a holder 102. The holder 102 includes an elongated body. In one example, the holder 102 may be made of a metal including, but not limited to, steel. For example, the holder 102 may be made of carbon steel, without limiting the scope of the present disclosure. The holder 102 includes a shank portion 104. The shank portion 104 is generally cylindrical in cross-section.

A sleeve 106 of the cutting tool 100 surrounds the shank portion 104. The sleeve 106 allows mounting of the cutting tool 100 in a socket (not shown) attached to a rotatable member such as the drum. The sleeve 106 tightly engages the socket and loosely engages the shank portion 104, allowing the cutting tool 100 to rotate during use. The sleeve 106 is slotted and is made of a resilient material. The sleeve 106 extends between an upper flange 108 and a lower flange 110 of the holder 102. The upper flange 108 and the lower flange 110 have diameters which are greater than that of the socket.

The holder 102 includes a head portion 112. The head portion 112 is coupled to the shank portion 104. The head portion 112 is generally conical in shape. The head portion 112 and the shank portion 104 may be manufactured as a unitary piece. Alternatively, the head portion 112 and the shank portion 104 may be manufactured as separate pieces and later assembled to form the holder 102. The head portion 112 is axially separated from the upper flange 108 by an annular recess 120.

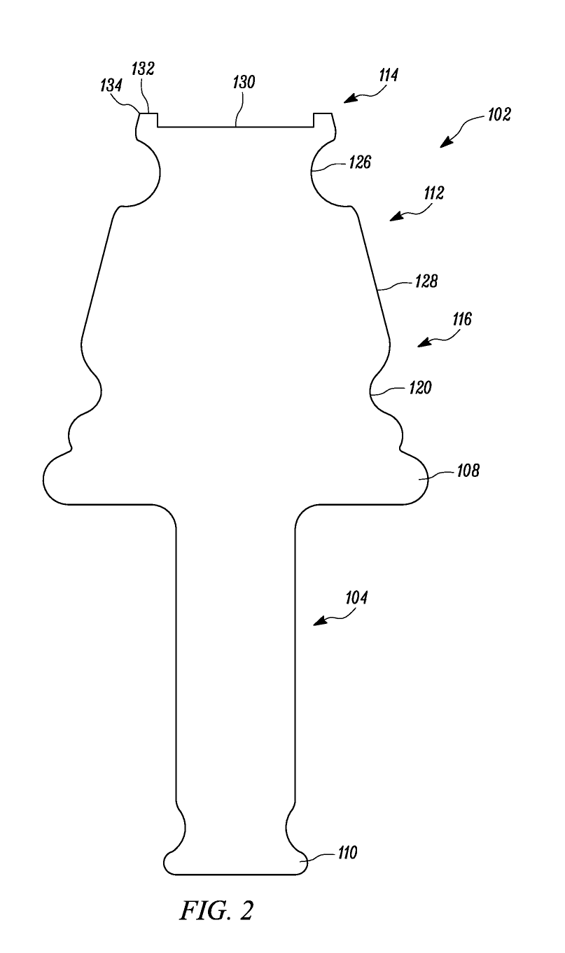

The head portion 112 includes a first end 114 and a second end 116. The first end 114 of the head portion 112 includes a cutting tool tip 118. The cutting tool tip 118 includes a bullet shaped design. The cutting tool tip 118 is coupled to the first end 114 of the head portion 112. In one example, the cutting tool tip 118 may be cemented or brazed to the head portion 112 into a cavity 130 (see FIG. 2) formed at the first end 114. Alternatively, any known coupling process may be used to couple the cutting tool tip 118 with the head portion 112, without any limitations. In one example, the cutting tool tip 118 may be made of a wear resistant material, such as carbide. For example, the cutting tool tip 118 may be made of a cemented tungsten carbide. In alternate examples, the cutting tool tip 118 may include a material such as a polycrystalline diamond.

Referring to FIG. 2, the head portion 112 of the holder 102 includes a groove 126. The groove 126 is created in the holder 102 proximal to the first end 114 of the head portion 112 that receives the cutting tool tip 118. In one example, the groove 126 may be created by a metal removing process, such as machining. In another example, the groove 126 may be created in the holder 102 during the manufacturing of the holder 102. For example, the groove 126 may be created during molding or casting of the holder 102. In yet another example, the groove 126 may be created during a forging process. The groove 126 extends circumferentially about the head portion 112 of the holder 102. The groove 126 may include a shape that corresponds to a wear pattern of the head portion 112. In one example, the groove 126 may include a concave arcuate cross-sectional configuration. In another example, the groove 126 may include a conic undercut. However, in other embodiments, the shape of the groove 126 may vary. For example, the groove 126 may include a rectangular cross-sectional configuration, a semi-circular cross-sectional configuration, a trapezoid cross-sectional configuration, and the like, without limiting the scope of the present disclosure.

The holder 102 of the cutting tool 100 is subjected to wear and tear during the operation of the cutting tool 100. More particularly, a portion 122 of the head portion 112 of the holder 102 proximal to the first end 114 is subjected to wear that sometimes causes premature failure of the holder 102. The wear experienced at the first end 114 causes reduction in dimensions at the head portion 112 of the holder 102.

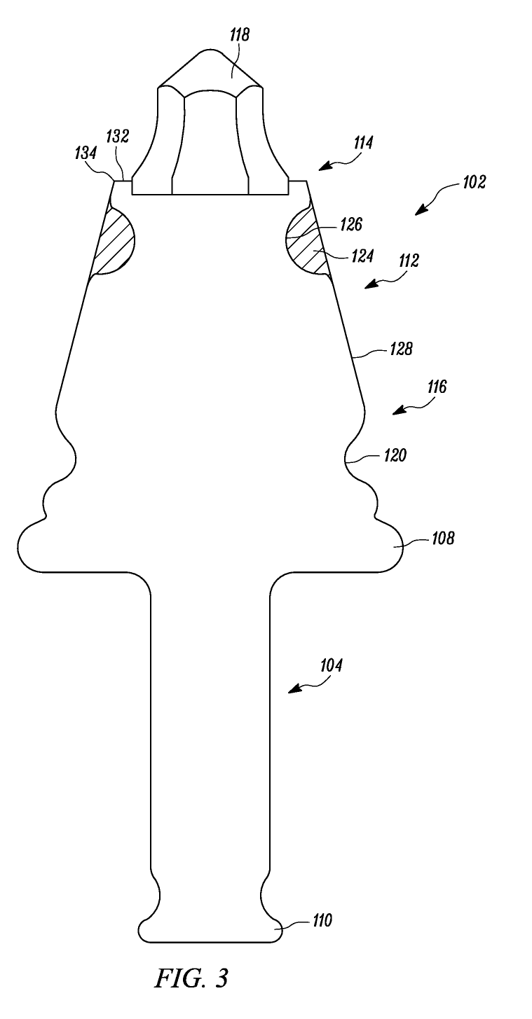

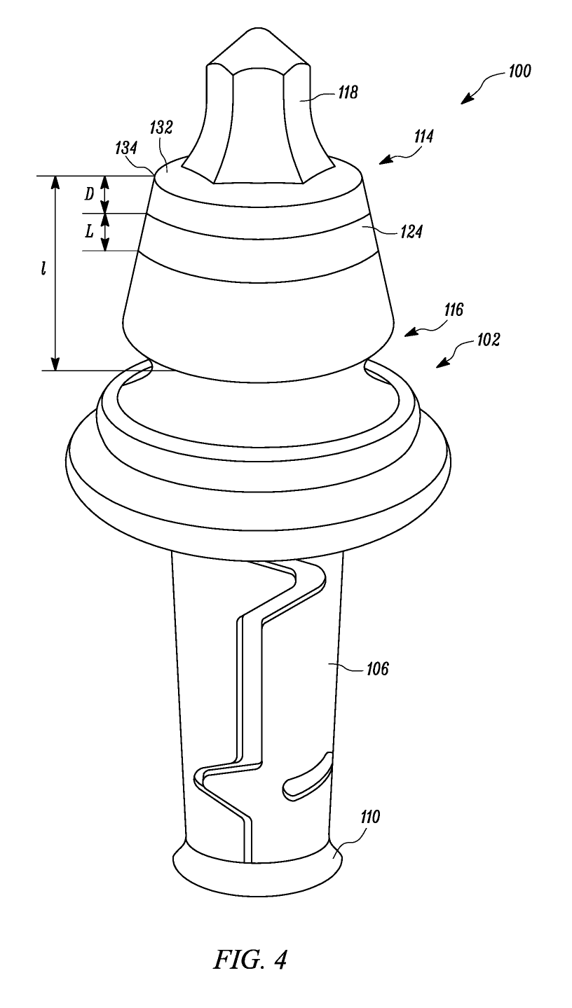

In order to mitigate the failure of the holder 102 due to wear, the head portion 112 of the holder 102 is selectively hardfaced by providing a wear resistant layer 124. Referring to FIGS. 3 and 4, the wear resistant layer 124 is formed proximal to the first end 114 of the head portion 112. In some examples, the wear resistant layer 124 is provided on the outer surface 128, and extends axially from an upper periphery 134 defined by an upper surface 132. The upper surface 132 is defined at the head portion 112 of the holder 102. The wear resistant layer 124 is formed within the groove 126 of the head portion 112 (see FIG. 3). The wear resistant layer 124 conforms to the outer surface 128 of the holder 102. The wear resistant layer 124 is formed by applying a wear resistant material. In one example, the wear resistant material is cladded within the groove 126 of the holder 102.

Referring to FIG. 3, the wear resistant material is cladded within the groove 126 created on the outer surface 128 of the holder 102. The wear resistant material may include a hard particle material, or a matrix of a hard particle material and a metal. Further, the wear resistant material may include a hard particle precipitating material, or a matrix of a hard particle precipitating material and a metal. In some examples, the wear resistant material includes a carbide, a boride, and/or cermet. In one example, the wear resistant material includes carbide former or boride former. In another example, the wear resistant material includes a solid state carbide or a solid state boride. It should be noted that the wear resistant material may include any composition that resists wear during the operation of the cutting tool 100.

It should be noted that the wear resistant material may be chosen based on the operation that the cutting tool 100 performs and also the amount of stress or wear on the head portion 112 during operation. Further, a dimension of the groove 126 may vary based on an amount of stress or wear on the head portion 112, or a dimension of the cutting tool 100.

In one example, a laser cladding process may be used to provide the wear resistant material in the groove 126. The laser cladding process may include any one of a powder laser cladding process or a wired laser cladding process. Further, the wear resistant material can be provided in the groove 126 by a metal deposition process or a metal spraying process. Any one of a thermal spray coating process, a vapor deposition process, or a chemical vapor deposition process may be used to provide the wear resistant material in the groove 126. Alternatively, any known method may be employed to clad the wear resistant material in the groove 126.

FIG. 4 is a perspective view of the cutting tool 100 having the wear resistant layer 124. In the illustrated example, the wear resistant layer 124 has a length “L” measured in an axial direction. It should be noted that the length “L” of the wear resistant layer 124 depicted in the accompanying figure is exemplary in nature. In some examples, the length “L” of the wear resistant layer 124 may be greater than or equal to one half of an overall length “1” of the head portion 112 of the holder 102, without limiting the scope of the present disclosure.

Further, the wear resistant layer 124 is located at a distance “D” measured in an axial direction, from the upper surface 132 of the head portion 112 of the holder 102. In an example where the groove 126 is embodied as the conic undercut, the wear resistant layer 124 may extend axially from the upper periphery 134 defined by the upper surface 132. In such an example, the distance “D” may be approximately equal to zero. It should be noted that the length “L” and the distance “D” are optimally selected in order to effectively mitigate wear of the holder 102. The length “L” and the distance “D” may be varied based on operational requirements.

Further, in some situations, the wear resistant layer 124 formed on the holder 102 may alter a microstructure of the holder 102. Thus, the cutting tool 100 is heat treated after the formation of the wear resistant layer 124 in order to harden the material of the holder 102. In one example, the cutting tool 100 is subjected to a heat treatment process for heat treating the cutting tool 100 after the cutting tool tip 118 is coupled to the head portion 112 of the holder 102. In another example, the holder 102 of the cutting tool 100 is heat treated before the cutting tool tip 118 is coupled to the head portion 112 of the holder 102. The heat treatment process may include any one or a combination of annealing, case hardening, precipitation strengthening, tempering, normalizing, and quenching, as per requirements.

### INDUSTRIAL APPLICABILITY

The present disclosure relates to the cutting tool 100 having the holder 102. The holder 102 includes the wear resistant layer 124. The wear resistant layer 124 is formed by cladding the wear resistant material within the groove 126 or the conic undercut of the holder 102. The wear resistant layer 124 provided on the holder 102 does not affect an overall geometry and design of the holder 102 as the wear resistant layer 124 is formed within the groove 126 of the holder 102. Thus, the present disclosure is directed towards a cost effective solution of improving wear resistance of the holder 102 without affecting the original geometry of the cutting tool 100.

By selectively hardfacing the holder 102, a retention time of the cutting tool 100 can be increased. Further, the wear resistant layer 124 reduces possibility of the failure of the holder 102 due to wear and tear, thereby allowing customers to increase replacement interval time. The holder 102 having the wear resistant layer 124 also increases useful life of the holder 102 and reduces the owning and operating costs for the customers.

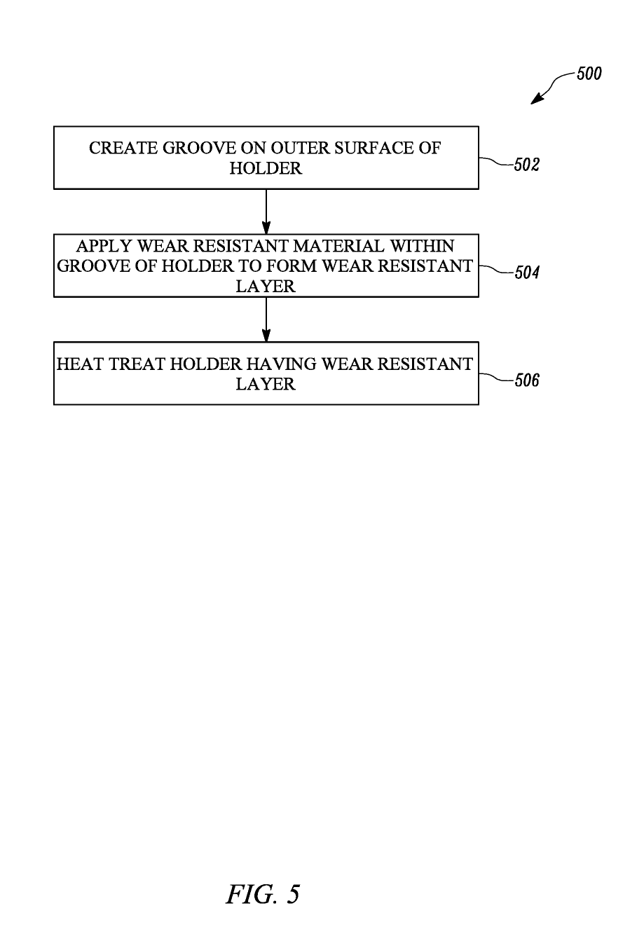

FIG. 5 is a flowchart for a method 500 of selectively hardfacing the holder 102 of the cutting tool 100. At step 502, the groove 126 is created on the outer surface 128 of the holder 102. The groove 126 is created proximal to the first end 114 of the head portion 112 that receives the cutting tool tip 118. The groove 126 extends circumferentially about the head portion 112 of the holder 102. The groove 126 includes the concave arcuate cross-sectional configuration or the conic undercut.

At step 504, the wear resistant material is applied within the groove 126 of the holder 102 to form the wear resistant layer 124. The wear resistant layer 124 conforms to the outer surface 128 of the holder 102. The step of applying the wear resistant material includes cladding the wear resistant material within the groove 126 of the holder 102. The wear resistant material includes one of a hard particle precipitating material, or a matrix of a hard particle precipitating material and a metal. In one example, the wear resistant material includes at least one of a carbide, a boride, and/or a cermet.

At step 506, the holder 102 having the wear resistant layer 124 is heat treated. Further, the cutting tool tip 118 is coupled to the head portion 112 of the holder 102, prior to the heat treating step. In another example, the cutting tool tip 118 is coupled to the head portion 112 of the holder 102, after the heat treating step.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method of selectively hardfacing a holder of a cutting tool, the method comprising:
creating a groove on an outer surface of the holder;
applying a wear resistant material within the groove of the holder to form a wear resistant layer; and
heat treating the holder having the wear resistant layer.

2. The method of claim 1, wherein the step of applying the wear resistant material includes cladding the wear resistant material.

3. The method of claim 1, wherein the wear resistant material includes a hard particle material or a matrix of a hard particle material and a metal.

4. The method of claim 3, wherein the wear resistant material includes at least one of carbide, boride, and cermet.

5. The method of claim 1 further comprising, conforming the wear resistant layer to the outer surface of the holder.

6. The method of claim 1 further comprising, coupling a cutting tool tip to a head portion of the holder, prior to the heat treating step.

7. The method of claim 6, wherein the groove is proximal to an end of the head portion that receives the cutting tool tip.

8. The method of claim 7, wherein the groove extends circumferentially about the head portion of the holder, the groove having at least one of a concave arcuate cross-sectional configuration and a conic undercut.

9. A holder for a cutting tool, the holder comprising:
a shank portion;
a head portion coupled to the shank portion, wherein one end of the head portion comprises a cutting tool tip; and
a groove created in the head portion, wherein a wear resistant layer is formed on the head portion by cladding a wear resistant material within the groove,
wherein the holder is heat treated after forming the wear resistant layer.

10. The holder of claim 9, wherein the wear resistant material includes a hard particle precipitating material or a matrix of a hard particle precipitating material and a metal.

11. The holder of claim 9, wherein the wear resistant layer conforms to the outer surface of the holder.

12. The holder of claim 9, wherein the cutting tool tip is coupled to the head portion of the holder prior to the heat treating of the holder.

13. The holder of claim 9, wherein the groove is proximal to the end of the head portion that comprises the cutting tool tip.

14. The holder of claim 13, wherein the groove extends circumferentially about the head portion of the holder, the groove having at least one of a concave arcuate cross-sectional configuration and a conic undercut.

15. A cutting tool comprising:
a holder comprising:
a shank portion;
a head portion coupled to the shank portion; and
a groove created in the head portion, wherein a wear resistant layer is formed on the head portion by cladding a wear resistant material within the groove,
wherein the holder is heat treated after forming the wear resistant layer; and
a cutting tool tip coupled to one end of the head portion.

16. The cutting tool of claim 15, wherein the wear resistant material includes a hard particle precipitating material or a matrix of a hard particle precipitating material and a metal.

17. The cutting tool of claim 15, wherein the wear resistant layer conforms to the outer surface of the holder.

18. The cutting tool of claim 15, wherein the cutting tool tip is coupled to the head portion of the holder prior to the heat treating of the holder.

19. The cutting tool of claim 15, wherein the groove is proximal to the end of the head portion that comprises the cutting tool tip.

20. The cutting tool of claim 19, wherein the groove extends circumferentially about the head portion of the holder, the groove having at least one of a concave arcuate cross-sectional configuration and a conic undercut.
